(19) United States
(12) Patent Application Publication
(10) Pub. No.: US 2015/0198484 A1
(43) Pub. Date: Jul. 16, 2015

(54) ELECTRONIC SHELF LABEL WITH AN OPTICAL ARRANGEMENT

(71) Applicant: PRICER AB, Stockholm (SE)

(72) Inventor: Björn Nilsson, Uppsala (SE)

(73) Assignee: PRICER AB, Stockholm (SE)

(21) Appl. No.: 14/413,096

(22) PCT Filed: Jun. 28, 2013
(86) PCT No.: PCT/SE2013/050829

§ 371 Date: Jan. 6, 2015

(30) Foreign Application Priority Data
Jul. 6, 2012 (SE) 1250795-0

(51) Int. Cl. G01J 5/08; G01J 5/04; G01J 5/10

(52) U.S. Cl. CPC G01J 5/0806; G01J 5/10; G01J 5/0862; G01J 5/04

(57) ABSTRACT

An electronic shelf label (ESL) is provided. The ESL includes a printed circuit board, PCB, a photo sensor sensitive to infra-red, IR, radiation and arranged at the PCB, an outer cover in which a window is arranged to admit light and IR radiation towards the photo sensor. The ESL further includes a filter arranged in front of the photo sensor and separate from the window, the filter being adapted to admit IR radiation and filter out light within the visible wavelength range. Further, the ESL includes index matching material transparent to IR radiation and coated on the PCB such that it covers the photo sensor and provides direct or indirect physical contact between the photo sensor and the filter. Such enables use of a photo sensor which is not pre-coated with index matching material, which reduces manufacturing costs.

### FIELD OF THE INVENTION

The present invention generally relates to the field of electronic shelf labels having optical arrangements for communicating with a central control unit.

### BACKGROUND OF THE INVENTION

An electronic shelf label (conventionally abbreviated ESL) is used for electronically displaying information such as price, label and product name for products and services available for customers. A plurality of ESLs is typically integrated in an ESL system for enabling central control of the information displayed on each ESL. The ESLs are communicating with a central control unit of the ESL system making it possible to frequently update and change the information displayed on the ESLs, which saves a considerable amount of time for the persons working in a store, especially if the number of different products in the store is high. As an example, a supermarket may offer around 5 000 to 20 000 different products.

In the ESL system, each ESL wirelessly communicates with one or more transceivers, which normally are mounted in the ceiling of the store. The transceivers in turn communicate with base stations connected to the central control unit. The communication between ESLs and the transceivers is effected by means of diffuse infra red (DIR) technology, which means that the transceivers emit infra red (IR) radiation in a wide beam and reflections from the ceiling, walls, floors and other natural surfaces are utilized to transmit the IR radiation to the ESLs. Hence, a line-of-sight is not required between the ESL and the transceiver.

For detecting IR signals from the transceivers, a photo sensor is arranged in each ESL. Variations in IR beam angles and distances between the ESLs and the transceivers imply technical challenges for achieving accurate IR detection at the ESL.

### SUMMARY OF THE INVENTION

It is with respect to the above considerations that the present invention has been made. An object of the present invention is to provide an improved alternative to prior art electronic shelf labels.

More specifically, it is an object of the present invention to provide an electronic shelf label having an improved sensitivity to diffuse infra red radiation. It is also an object of the present invention to provide a method of manufacturing such an electronic shelf label.

These and other objects of the present invention are achieved by means of an electronic shelf label and a method of manufacturing an electronic shelf label having the features defined in the independent claims. Preferable embodiments of the invention are defined by the dependent claims.

Hence, according to a first aspect of the present invention, an electronic shelf label (ESL) is provided. The ESL comprises a printed circuit board (PCB), a photo sensor sensitive to infra red (IR) radiation and arranged at the PCB, an outer cover in which a window is arranged to admit light and IR radiation towards the photo sensor. The ESL further comprises a filter arranged in front of the photo sensor and separate from the window, the filter being adapted to admit IR radiation and filter out light within the visible wavelength range. Further, the ESL comprises index matching material transparent to IR radiation and coated on the PCB such that it covers the photo sensor and provides direct or indirect physical contact between the photo sensor and the filter.

According to a second aspect of the present invention, a method of manufacturing an ESL is provided. The method comprises providing a PCB, arranging a photo sensor sensitive to IR radiation at the PCB, and applying index matching material transparent to IR radiation on the PCB such that the index matching material covers, and is in direct or indirect physical contact with, the photo sensor. The method further comprises arranging a filter in front of the photo sensor such that the filter is in direct or indirect physical contact with the index matching material and the photo sensor. The filter is adapted to admit IR radiation and filter out light within the visible wavelength range. Further, an outer cover having a window is arranged such that the window admits light and IR radiation towards the photo sensor.

The refractive index of commercially available photo sensors is significantly higher than the refractive index of air, which has a refractive index of approximately 1.0. Photo sensors may have refractive indices of around 3.0. The high difference in the refractive indices between air and the photo sensor causes a considerable amount of impinging IR radiation (and light) to be reflected instead of absorbed by the photo sensor. With the present invention, the index matching material (or optical coating) coated on the PCB provides a direct or indirect physical contact between the filter and the photo sensor, whereby the IR radiation does not have to travel through air between the filter and the photo sensor, which improves the optical contact between the filter and the photo sensor. For example, the index matching material may be sandwiched between the photo sensor and the filter for providing physical contact between them. The improved optical contact reduces the reflection of IR radiation (and light) at the surface of the photo sensor and more of the impinging IR radiation reaches the photo sensor, which is advantageous in that the ESL is more sensitive to diffuse IR radiation. The index matching material may also be referred to as a refractive index matching material.

Further, the present invention is advantageous in that the index matching material is coated on the PCB such that it covers the photo sensor, thereby enabling use of a photo sensor which is not pre-coated with index matching material, which reduces manufacturing costs. Hence, the photo sensor may first be mounted to the PCB and subsequently, the index matching material may be applied as a coating over the photo sensor. Applying the index matching material during the assembly process is advantageous in that the index matching material may be applied in a liquid state and function as an adhesion between the photo sensor and the filter.

In the present disclosure, the term “direct or indirect physical contact” means a contact between two elements, wherein there is no space with air (or any other gas or vacuum) present at the contact boundary. In case of direct physical contact, the two elements are adjacent to each other without any space in between. In case of indirect physical contact, a third element may be sandwiched between the two elements such that it physically interconnects them.

According to an embodiment of the invention, the filter may be adhered to the photo sensor by means of the index matching material. Hence, the filter may be fastened to the photo sensor by the index matching material, which is advantageous in that additional adhesive may not be required. Omitting additional adhesive provides an improved optical contact between the filter and the photo sensor and a facilitated manufacturing process. Arranging the filter in front of the filter may thus comprise adhering the filter (or an optical element comprising the filter) to the photo sensor with the index matching material as an adhesive.

According to an embodiment, the filter may be comprised in a filter lens arranged to converge (or direct) IR radiation towards the photo sensor.

Hence, the filter may be incorporated into a lens, whereby a single optical element is provided instead of two separate components. The converging of IR radiation towards the photo sensor is advantageous in that more of the impinging IR radiation (also from wide angels) is directed towards the photo sensor. The filter lens may be arranged at the index matching material such that the index matching material provides physical contact between the filter lens and the photo sensor. The filter lens may e.g. be adhered (or fastened) to the photo sensor by means of the index matching material. The filter in the filter lens may e.g. be provided by filter particles and/or a filter layer arranged in and/or on the filter lens.

In an embodiment of the present invention, the refractive index of the index matching material may match (or substantially correspond to) the refractive index of the filter lens. With the present embodiment, light losses are reduced and the optical contact between the index matching material and the filter lens is improved, as less light is reflected when crossing the boundary between the index matching material and the filter lens. For example, the refractive index of the index matching material may correspond to 75-125%, and preferably 90-110%, of the refractive index of the filter lens for reducing light losses at the boundary between the index matching material and the filter lens.

According to an embodiment of the invention, the index matching material may be formed as a lens adapted to converge (or direct) IR radiation towards the photo sensor. By having the index matching material formed as a lens, a separate lens element adhered to the index matching material may be omitted, whereby the number of components are reduced, which in turn facilitates manufacturing and reduces manufacturing costs. In the manufacturing process, the index matching material may be applied as a drop covering the photo sensor. When the drop of index matching material has been applied, its natural shape will include a convex upper surface adapted to direct impinging IR radiation towards the photo sensor. Applying the index matching material as a drop further facilitates manufacturing and reduces manufacturing costs.

According to an embodiment, the index matching material may comprise filter particles adapted to admit IR radiation and filter out light within the visible wavelength range. Hence, the filter may be incorporated in the index matching material, which further facilitates manufacturing.

The index matching material is preferably a material, which may be applied to the PCB in a liquid form and which subsequently, preferably after mounting the filter lens to the index matching material, solidifies. For example, the index matching material may comprise epoxy or silicone, which are optically transparent materials having such characteristics.

In the following, an electronic shelf label (ESL) is provided. The present ESL and may be an embodiment of the ESL as defined in the present invention. However, the present ESL may also be dissociated from the present invention and implemented on its own. For example, the ESL as described below may not necessarily include a filter arranged in front of the photo sensor or index matching material coated on the PCB.

The present ESL comprises a printed circuit board (PCB), a photo sensor sensitive to infra red (IR) radiation and arranged at the PCB, and an outer cover in which a window is arranged to admit light and IR radiation towards the photo sensor. The window may have an elevated portion arranged to refract light and IR radiation towards the photo sensor. The present ESL is advantageous in that more IR radiation (and light) is directed towards the photo sensor, as radiation impinging at the window at wide angles (i.e. at angles close to 0 degrees against the outer cover) is refracted by the elevated portion towards the photo sensor. Hence, the IR detection of the ESL is less dependent on the impinging angle of IR radiation, whereby the ESL is more sensitive to diffuse IR radiation.

According to an embodiment, a sidewall of the elevated portion may be arranged to refract light and IR radiation towards the photo sensor. The sidewall of the elevated portion may be referred to as a portion surrounding the upper (or even uppermost) portion of the elevated portion. The sidewall may in particular be adapted to refract light impinging at wide angles against the outer cover. Further, the sidewall may be inclined relative to a flat upper surface of the elevated portion, thereby forming a prism-like shape, whereby the side wall captures light at wide angles against the cover and directs is towards the photo sensor.

According to another concept, which may be combined with the present invention and/or with any of the previously described embodiments, an ESL may comprise a PCB, a photo sensor sensitive to IR radiation and arranged at the PCB, a filter arranged in front of the photo sensor and adapted to admit IR radiation and filter out light within the visible wavelength range, an outer cover in which a window is arranged to admit light and IR radiation towards the photo sensor and an optical body arranged to provide direct or indirect physical contact between the window and the filter. With the optical body, the IR radiation does not have to travel through air between the window and the filter, which improves the optical contact between the filter and the photo sensor. The improved optical contact reduces the reflection of IR radiation (and light) at the surface of the filter and more of the impinging IR radiation reaches the photo sensor, which is advantageous in that the ESL is more sensitive to diffuse IR radiation. The optical body may preferably be optically transparent and may e.g. comprise plastic and/or glass. The optical body may form a waveguide for light traveling from the window to the filter, wherein light may be reflected by total internal reflection against the sidewalls of the optical body towards the photo sensor. Further, the refractive index of the optical body may preferably match the refractive index of the window for reducing reflection at the boundary between the window and the optical body.

According to another concept, which may be combined with the present invention and/or with any of the previously described concepts or embodiments, an ESL may comprise a PCB, a photo sensor sensitive to IR radiation and arranged at the PCB, an outer cover in which a window is arranged to admit light and IR radiation towards the photo sensor, and a reflector arranged to reflect light and IR radiation admitted by the window towards the photo sensor. With the reflector, more of the light and IR radiation admitted by the window is directed towards the sensor.

Further objectives of, features of, and advantages with, the present invention will become apparent when studying the following detailed disclosure, the drawings and the appended claims. Those skilled in the art realize that different features of the present invention can be combined to create embodiments other than those described in the following. In particular, it will be appreciated that the various embodiments described for the ESL are all combinable with the method as defined in accordance with the second aspect of the present invention.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, in which:

FIG. 1 shows an electronic shelf label according to an embodiment of the present invention;

FIG. 2 is an exploded view of the electronic shelf label shown in FIG. 1;

FIG. 3 is a cross section view taken along line A-A in FIG. 1;

FIG. 4 is an enlarged view of section B in FIG. 3; and

FIG. 5 shows a method of manufacturing an electronic shelf label according to an embodiment of the present invention.

All the figures are schematic, not necessarily to scale, and generally only show parts which are necessary in order to elucidate the invention, wherein other parts may be omitted or merely suggested.

### DETAILED DESCRIPTION OF EMBODIMENTS

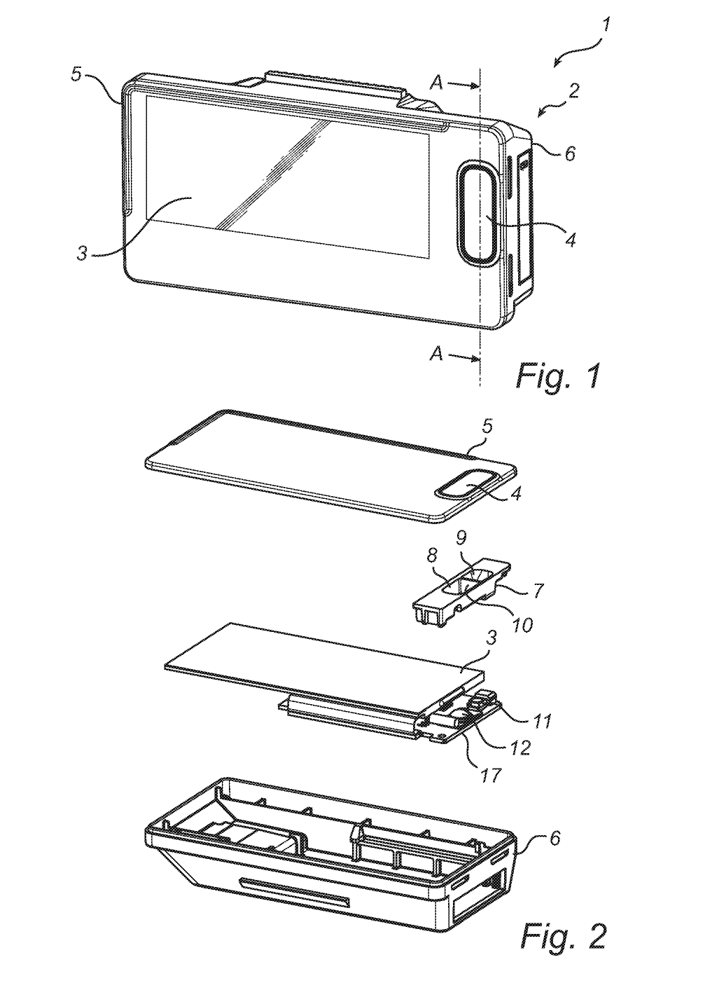

With reference to FIGS. 1 to 4, an electronic shelf label (ESL) according to an embodiment of the present invention will be described.

The ESL 1 according to the present embodiment may be a part of an ESL system comprising a plurality of ESLs for use in a store. The ESL 1 may be used for displaying information (such as label, price and product information) to customers in the store. The ESLs in the system communicate with a central control unit of the ESL system making it possible to update and change the information displayed on the ESLs. Each ESL communicates via diffuse IR radiation with transceivers mounted in the ceiling of the store. The transceivers communicate with base stations, e.g. via a twisted pair cable network, and the base stations in turn communicate with the central control unit (or server) e.g. via an Ethernet network, a serial link or wirelessly. The communication between the ESLs and the central control unit may preferably be a two-way communication for enabling updating information in the ESL and sending acknowledgement receipts from the ESL back to the central control unit.

As shown in FIGS. 1 and 2, the ESL 1 comprises an outer cover 2 (or casing) including a front part 5 adapted to face customers and a rear part 6. The rear part 6 may comprise means for mounting the ESL 1 to a shelf or the like (not shown). The ESL 1 further comprises a display 3 for displaying product information.

For managing the IR communication with the transceivers, the ESL 1 comprises a photo sensor 12 sensitive to IR radiation (and optionally also visible light) and preferably also an IR light emitting diode (LED) 11 for transmitting IR signals arranged at a PCB 17. The PCB 17 may be any kind of PCB, such as a flexible or rigid PCB. The photo sensor 12 and the IR LED 11 are covered by an IR transparent window 4 (or communication window) included in the front part 5 of the outer cover 2. Between the front part 5 and the PCB 17, a partition part 7 is arranged for providing a photo sensor chamber 8 and an IR LED chamber 9 separate from each other, as shown in FIGS. 2 and 4. IR radiation from the IR LED 11 reaching the photo sensor 12 is thereby reduced. The partition part 7 may preferably be moulded in a single piece of material, such as in plastic and provided with reflecting means on the inner walls 10, 13 of the chambers 8, 9. For example, the inner walls may be coated with a reflective film (such as being metalized) or provided with metal sheets or any other specular or diffuse reflecting means.

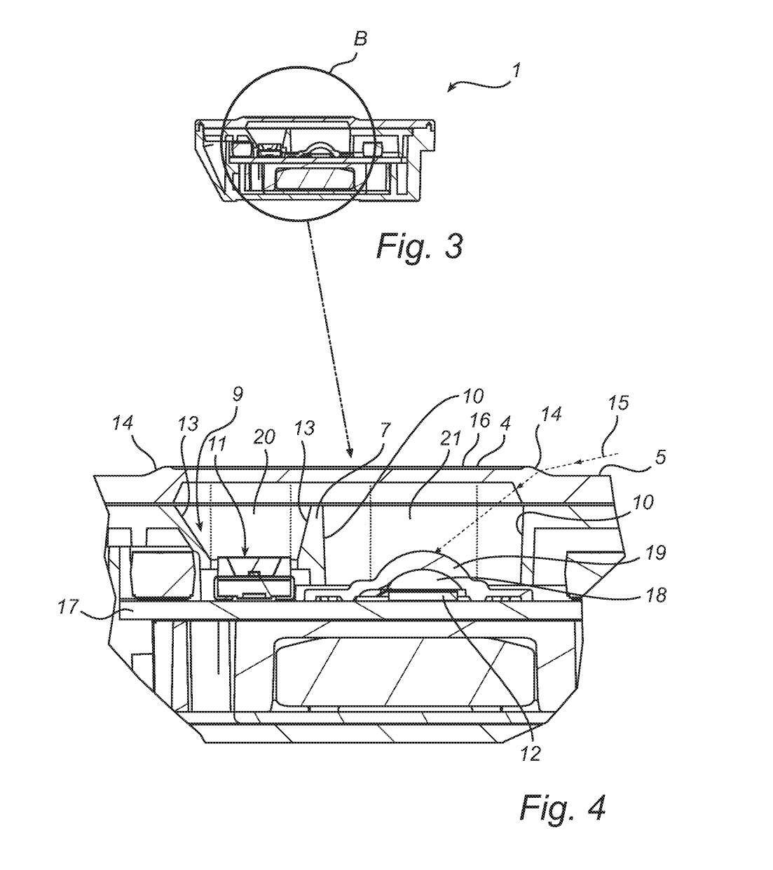

The optical arrangement at the photo sensor 12 and the IR LED 11 will be described in more detail with reference in particular to FIGS. 3 and 4 in the following.

The window 4 may preferably comprise an elevated portion slightly elevated over the surrounding portion of the outer cover (or front part 5). The elevated portion has an upper, preferably flat, surface 16, elevated by a sidewall 14 connecting the upper portion 16 to the surrounding portion of the outer cover. The sidewall 14 is inclined relative to the upper surface 16, thereby providing a prism-like shape at the periphery of the window 4. A beam (including IR radiation) impinging on the sidewall 14 at a wide angel (i.e. with a small angle against the outer cover and the flat upper surface 16) is thereby refracted by the sidewall 14 and directed towards the photo sensor 12, as illustrated by arrow 15 in FIG. 4.

The IR LED 11 and the photo sensor 12 may be mounted in proximity to each other on the PCB 17 and optically separated by an intermediate wall of the partition part 7. The inner walls 10 of the photo sensor chamber 8 are coated with a reflective film for reflecting IR radiation (and light) admitted by the window towards the photo sensor 12. Further, the inner walls 13 of the IR LED chamber 9 are coated with reflective film for reflecting IR radiation emitted by the IR LED out of the outer cover.

A filter lens 19 is arranged in front of the photo sensor 12. The filter lens 19 includes a lens for directing IR radiation and light towards the photo sensor 12 and a filter for filtering out light within the visible wavelength range and admitting IR radiation. Having a filter in front of the photo sensor 12 allows having a photo sensor 12 having a wide sensitivity range including also visible light, which is a cheaper component than a photo sensor sensitive to merely IR radiation. Further, the filter may preferably be formed by filter particles spread in the lens or applied to a surface of the lens. Alternatively, the filter may be formed by a layer or film arranged in or on the lens. For improving the optical contact between the filter lens 19 and the photo sensor 12, index matching material 18 is arranged such that it physically interconnects the filter lens 19 and the photo sensor 12. The PCB 17 is partly coated with the index matching material 18 such that the index matching material 18 covers the photo sensor 12 and optionally such that it also covers an area of the PCB 17 laterally surrounding the photo sensor 12. Preferably, the index matching material 19 functions as an adhesive adhering the filter lens 19 to the photo sensor 12.

The index matching material 18 may e.g. be optically transparent (or at least IR transparent) epoxy or silicone. The refractive index of the index matching material 18 may preferably match the refractive index of the filter lens 19 for improving the optical contact there between. For example, the refractive indices of the index matching material 18 and/or the filter lens 19 may be comprised in the range of about 1.3 to 1.8, such as around 1.5. A (slight) difference between the two indices may be envisaged. For example, the refractive index of the index matching material 18 may correspond to 75-125%, and preferably 90-110%, of the refractive index of the filter lens 19.

In an embodiment, the refractive index of the index matching material 18 may be slightly higher than the refractive index of the filter lens 19, thereby providing a stepwise increase of the refractive index from air (above the filter lens 19), which has a relatively low refractive index (around 1.0), to the photo sensor 12 which may have a relatively high refractive index (around 3.0). For example, the filter lens 19 may have a refractive index of comprised in the interval 1.3-1.8 and the index matching material 18 may have a refractive index of comprised in the interval 1.8-2.3.

Optionally, an optical body 21 (represented by dashed lines in FIG. 4), such as a piece of transparent plastic or glass, may be arranged between the filter lens 19 and the window 4, such that it provides physical contact between them. The optical body 21 may reach from the filter lens 19 up to the (underside of) window 4, thereby providing a waveguide for light and IR radiation there between. For the same purpose, another (additional) optical body 20 (represented by dashed lines in FIG. 4), may be arranged between the IR LED 11 and the window 4, such that it provides physical contact between them.

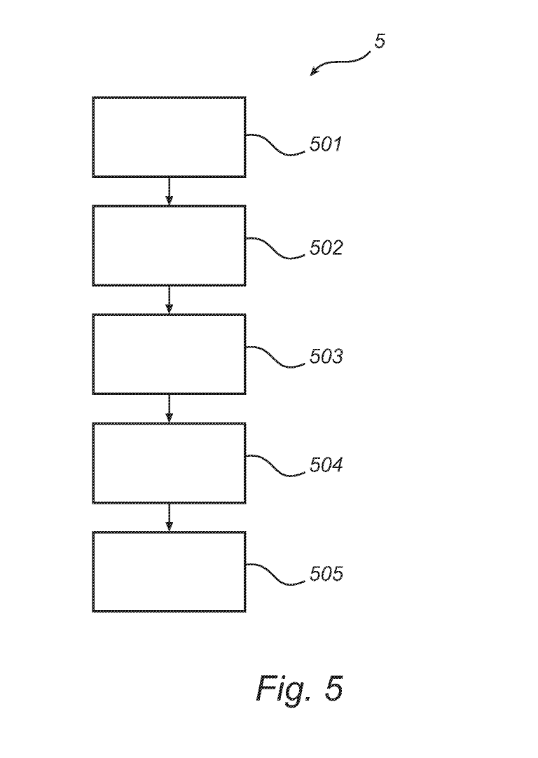

With reference to FIG. 5, a method of manufacturing an ESL according to an embodiment will be described. The method 5 comprises the steps of providing 501 a PCB, arranging 502 a photo sensor sensitive to IR radiation at the PCB, and applying 503 index matching material transparent to IR radiation on the PCB such that the index matching material covers, and is in direct or indirect physical contact with, the photo sensor. The method 5 further comprises arranging 504 a filter in front of the photo sensor such that the filter is in direct or indirect physical contact with the index matching material and the photo sensor. The filter is adapted to admit IR radiation and filter out light within the visible wavelength range. For example, the refractive index may be applied in liquid form as at least one drop on the photo sensor and optionally also as at least one drop on the area of the PCB in proximity to the photo sensor. Subsequently, the filter (e.g. being comprised in a filter lens) may be positioned at (and pressed onto) the photo sensor such that it adapts the liquid index matching material to the shape of the underside of the filter and the upper side of the photo sensor and preferably such that any air pockets between the filter and the photo sensor are reduced. When the filter is properly positioned, the index matching material solidifies and thereby adheres the filter to the photo sensor. Further, an outer cover having a window is arranged 505 such that the window admits light and IR radiation towards the photo sensor.

While specific embodiments have been described, the skilled person will understand that various modifications and alterations are conceivable within the scope as defined in the appended claims.

For example, the filter may be arranged as a separate element (not in a filter lens) adhered to the photo sensor by means of the index matching material. Further, the filter may be formed by filter particles comprised in the index matching material.

1. An electronic shelf label comprising:
a printed circuit board, PCB;
a photo sensor sensitive to infra red, IR, radiation and arranged at the PCB;
an outer cover in which a window is arranged to admit light and IR radiation towards the photo sensor;
a filter arranged in front of the photo sensor and separate from the window, the filter being adapted to admit IR radiation and filter out light within the visible wavelength range; and
index matching material transparent to IR radiation and coated on the PCB such that it covers the photo sensor and provides direct or indirect physical contact between the photo sensor and the filter.

2. The electronic shelf label as defined in claim 1, wherein the filter is adhered to the photo sensor by means of the index matching material.

3. The electronic shelf label as defined in claim 1, wherein the filter is comprised in a filter lens arranged to converge IR radiation towards the photo sensor.

4. The electronic shelf label as defined in claim 3, wherein the refractive index of the index matching material matches the refractive index of the filter lens.

5. The electronic shelf label as defined in claim 3, wherein the refractive index of the index matching material corresponds to 75-125%, and preferably 90-110%, of the refractive index of the filter lens.

6. The electronic shelf label as defined in claim 1, wherein the index matching material is formed as a lens adapted to converge IR radiation towards the photo sensor.

7. The electronic shelf label as defined in claim 1, wherein the index matching material comprises filter particles adapted to admit IR radiation and filter out light within the visible wavelength range.

8. The electronic shelf label as defined in claim 1, wherein the index matching material comprises epoxy or silicone.

9. The electronic shelf label as defined in claim 1, wherein the window has an elevated portion arranged to refract light and IR radiation towards the photo sensor.

10. The electronic shelf label as defined in claim 9, wherein a sidewall of the elevated portion is arranged to refract light and IR radiation towards the photo sensor.

11. The electronic shelf label as defined in claim 10, wherein the sidewall is inclined relative to a flat upper surface of the elevated portion.

12. The electronic shelf label as defined in claim 1, further comprising an optical body arranged to provide direct or indirect physical contact between the window and the filter.

13. The electronic shelf label as defined in claim 1, further comprising a reflector arranged to reflect light and IR radiation admitted by the window towards the photo sensor.

14. A method of manufacturing an electronic shelf label, the method comprising:
providing a printed circuit board, PCB;
arranging a photo sensor sensitive to infra red, IR, radiation at the PCB;
applying index matching material transparent to IR radiation on the PCB such that the index matching material covers, and is in direct or indirect physical contact with, the photo sensor; and
arranging a filter in front of the photo sensor such that the filter is in direct or indirect physical contact with the index matching material and the photo sensor, the filter being adapted to admit IR radiation and filter out light within the visible wavelength range; and
arranging an outer cover having a window such that the window admits light and IR radiation towards the photo sensor.
